(19) United States
(12) Patent Application Publication
(10) Pub. No.: US 2025/0115475 A1
(43) Pub. Date: Apr. 10, 2025

(54) DRY HYDROGEN PRODUCTION DEVICE AND METHOD

(71) Applicants: SK GAS CO., LTD., Seongnam-si, Gyeonggi-do (KR); EWHA UNIVERSITY - INDUSTRY COLLABORATION FOUNDATION, Seoul (KR)

(72) Inventors: Woo Jae KIM, Seoul (KR); Ung Gi HONG, Seongnam-si, Gyeonggi-do (KR); Hyeong Chan AHN, Seongnam-si, Gyeonggi-do (KR); Tae Hyeop KIM, Seongnam-si, Gyeonggi-do (KR)

(73) Assignees: SK GAS CO., LTD., Seongnam-si, Gyeonggi-do (KR); EWHA UNIVERSITY - INDUSTRY COLLABORATION FOUNDATION, Seoul (KR)

(21) Appl. No.: 18/729,063

(22) PCT Filed: Jan. 16, 2023
(86) PCT No.: PCT/KR2023/000717

§ 371 Date: Jul. 15, 2024

(30) Foreign Application Priority Data
Jan. 14, 2022 (KR) 10-2022-0005963

(51) Int. Cl. C01B 3/06; B01D 53/047; B01J 8/00; B01J 8/18; C01B 3/56; C01D 7/07

(52) U.S. Cl. CPC C01B 3/06; B01D 53/047; B01J 8/005; B01J 8/1818; B01J 8/1836; C01B 3/56; C01D 7/07; B01D 2257/504; B01J 2208/00132; C01B 2203/042

(57) ABSTRACT

A dry hydrogen production device includes: a reactor to which water or vapor is not supplied; heating means configured to heat the reactor to 200 to 800° C.; a supply line for hydroxide of at least one of alkali and alkali earth connected to the reactor; a biomass supply line connected to the reactor; at least one carrier gas supply line connected to the reactor; a gas phase reaction product outflow line connected to the reactor, a solid-gas separator connected to the gas phase reaction product outflow line; and a gas separator connected to the solid-gas separator.

### CROSS-REFERENCE TO PRIOR APPLICATIONS

This Application is a National State Patent Application of PCT International Application No. PCT/KR2023/000717 (filed on Jan. 16, 2023), which claims priority to Korean Patent Application No. 10-2022-0005963 (filed on Jan. 14, 2022), which are all hereby incorporated by reference in their entirety.

### BACKGROUND

The present disclosure relates to a device and method for producing hydrogen from dried biomass without the supply of vapor or water.

The increasing concern over greenhouse gas emissions and global warming has heightened the demand for developing and disseminating new renewable energy sources to replace fossil fuels. Hydrogen, considered as a clean energy option, is gaining attention due to its abundance on Earth in various forms such as fossil fuels, biomass, and water. Efficient and environmentally friendly hydrogen production methods are crucial for its use as a fuel.

Hydrogen production methods include traditional fossil fuel reforming techniques and renewable methods using biomass and water. Traditional methods include steam reforming, partial oxidation, autothermal reforming, and gasification.

Renewable methods are categorized into thermochemical and biological processes using biomass, while water-based methods include electrolysis, thermal decomposition, and photolysis.

Currently, approximately 96% of hydrogen is produced through fossil fuel reforming, with biomass-based production remaining minimal. Despite this, biomass is recognized as a clean energy source due to its carbon cycle impact, it is necessary to investigate more efficient hydrogen production methods from biomass for industrial applications.

There is growing interest in re-evaluating food waste (sludge) as an energy resource rather than viewing it solely as a nuisance waste, though effective solution has not yet been found.

Specifically, U.S. Pat. No. 4,822,497 discusses a pressure vessel acting as a reactor for oxidizing harmful substances in supercritical water, facing challenges related to salt formation and removal under reaction conditions.

According to “Gasification of waste to produce low-BTU gas by Molten Salt Technique,” published in the Journal of the Institution of Engineers India (1989), by Y. Raja, significant biomass vaporization occurs in dry salt melts, yet carbon monoxide production remains a concern. Further steps such as a shift converter for hydrogen production are recommended, with challenges in preventing charcoal or coke formation during conversion in dry salt melts.

DE 202 20 307 U1 discloses a device for handling a fluid material in supercritical water. In this case, the device is formed of a cylindrical reactor equipped with pressure pipes for a starting material supply line and a product discharge line. Here, the product discharge line is formed as an upright pipe. In this case, this pipe protrudes into a reaction chamber from above, and terminates at one-third of a reactor height, with a bottom outlet installed at the bottom of the reactor, which is located at its narrowest section. It has valves arranged for a cooler and continuous (or intermittent) bottom discharge.

U.S. Pat. No. 6,878,479 B2 discloses a device for directly converting fuel into electrical energy. Here, an electrochemical cell in which a melted electrolyte is present each time has a bipolar tilted structure, and is arranged so that electrical resistance between cells is minimal.

According to “Comparison of the Effects of the addition of NaOH on the decomposition of 2-chlorophenol and phenol in supercritical water and under supercritical water oxidation conditions,” J. Supercritical Fluids, vol. 24, page 239 to 250, 2002, by G. Lee, T. Nunoura, Y. Matsumura, and K. Yamamoto, it is known that the effects of NaOH on the decomposition of an organic compound should be taken into account when determining optimized reaction conditions and optimized reactor design.

According to “Bubble points of the Systems isopropanol-water, isopropanol-water-sodium acetate and isopropanol-water-sodium oleate at high pressure,” Fluid Phase Equilibria, vol. 244, page 78 to 85, 2006, by M. D. Bermejo, A. Martin, L. J. Florusse, C. J. Peters, and M. J. Cocero, it is known that oxidation in supercritical water represents an effective technique for the decomposition of organic waste with high yields.

Korean Patent Publication KR2002-0055346 discloses a method and device for producing methanol using a biomass raw material. To be more specific, the patent discloses a methanol production device using a biomass raw material, which includes a hydrogen gas supply means to continuously supply hydrogen gas required for reaction from gases produced by gasifying biomass.

Korean Patent No. KR10-2138897 relates to a biomass fuel processing system for a hydrogen fuel cell vehicle. More particularly, it discloses a biomass fuel processing system for a hydrogen fuel cell vehicle that includes a filter to maintain reaction conditions.

### SUMMARY

While various methods for conventional food waste (sludge) treatment have been proposed, this disclosure aims to offer an efficient and effective approach. One embodiment introduces a clean technology for hydrogen production from dried biomass without the need for additional steam or water, thereby generating hydrogen as a clean energy source without unnecessary harmful by-products.

Preferable is a dry hydrogen production device from sludge, the device includes,
a reactor to which water or vapor is not supplied;
a heating means configured to heat the reactor from 100 to 800° C.;
a supply line for hydroxide of at least one of alkali and alkali earth connected to the reactor;
a biomass supply line connected to the reactor;
at least one carrier gas supply line connected to the reactor;
a gas phase reaction product outflow line connected to the reactor;
a solid-gas separator connected to the gas phase reaction product outflow line; and
a gas separator connected to the solid-gas separator.

The alkali hydroxide may be sodium hydroxide.

The device may further include a wastewater treatment device communicating with the solid-gas separator.

The device may further include a dryer between the solid-gas separator and the gas separator.

The device may further include a carbon dioxide supply line connected to the reactor.

The device may further include a carbon dioxide outflow line separating carbon dioxide from the gas phase reaction product outflow line, and discharging the carbon dioxide.

The carrier gas may be air, nitrogen, or inert gas.

The device may further include a solid-product discharge line connected to the reactor.

The solid product may include carbonate of at least one of alkali and alkaline earth.

The solid product may include sodium carbonate.

The device may further include a device connected to a rear end of the solid-product discharge line to increase purity of the solid product.

The gas separator may be a pressure swing adsorption (PSA) device.

The heating means may be a tube type heat exchanger.

Preferable is a dry hydrogen production method from biomass, the method includes steps of,
supplying biomass to the reactor;
producing a reaction product by heating the reactor from 100-800° C. without supplying
water or vapor, while supplying carrier gas to fluidize a hydroxide and biomass mixture in the reactor;
discharging a produced gas phase reaction product from the reactor;
separating the gas phase reaction product into a gas effluent and a solid effluent through solid-gas separation; and
producing a gas product through gas-gas separation from the gas effluent.

The alkali hydroxide may be sodium hydroxide.

The method may further include a wastewater treatment step for treating the solid effluent separated from the solid-gas separation.

The method may further include a step of drying the gas effluent prior to the step (6).

The method may further include a step of supplying carbon dioxide to a lower portion of the reactor to convert hydroxide of at least one of alkali and alkaline earth into carbonate of at least one of alkali and alkaline earth.

The method may further include a step of separately separating and discharging carbon dioxide during the step of discharging the gas phase reaction product.

The method may further include a step of supplying the carrier gas to an upper portion of the reactor to discharge a solid product containing carbonate of at least one of alkali and alkaline earth from the lower portion of the reactor.

The carrier gas may be air, nitrogen, or inert gas.

The alkali carbonate may be sodium carbonate.

The method may further include a step of increasing purity of the solid product subsequent to the step of discharging the solid product from the lower portion of the reactor.

A supply amount of biomass to the loaded alkali hydroxide may be 1 to 3:1 (alkali hydroxide:biomass) in a dry weight ratio.

The dry hydrogen production technology according to the present disclosure is a clean technology for producing hydrogen from dried biomass without supplying vapor or water, has a low load on a device, consumes less energy because it does not use water with high specific heat, and can produce hydrogen as clean energy without unnecessary harmful by-products.

Moreover, it can be an alternative to solve environmental problems caused by incineration or landfill disposal of food waste.

### BRIEF DESCRIPTION OF THE DRAWINGS

FIGS. 1 to 4 schematically show a device for implementing the present disclosure in an operating order.

### DETAILED DESCRIPTION

Preferably, a dry hydrogen production device from sludge according to the present disclosure includes,
a reactor to which water or vapor is not supplied;
a heating means configured to heat the reactor from 100 to 800° C.;
a supply line for hydroxide of at least one of alkali and alkali earth connected to the reactor;
a biomass supply line connected to the reactor;
at least one carrier gas supply line connected to the reactor;
a gas phase reaction product outflow line connected to the reactor;
a solid-gas separator connected to the gas phase reaction product outflow line; and
a gas separator connected to the solid-gas separator.

Hereinafter, preferred embodiments of the present disclosure will be described with reference to the accompanying drawings. However, the present disclosure may be implemented in various ways without being limited to particular embodiments described herein.

In describing the embodiments, the same names and characters are used to designate the same components, and a duplicated description thereof will be omitted herein. Like reference numerals refer to like components throughout various figures. In the accompanying drawings, the sizes of components may be exaggerated for clarity of illustration.

In addition, the term “or” is intended to mean an inclusive “or” and not an exclusive “or.” That is, unless otherwise specified or the context clearly indicates otherwise, “X utilizes A or B” is intended to mean one of natural implicit substitutions. In other words, if X uses A; X uses B; or X uses both A and B, “X uses A or B” may be applied to these cases. Further, the term “and/or” as used herein should be understood to refer to and include all possible combinations of one or more of the related listed items.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

In the present disclosure, the singular forms are intended to include the plural forms as well, unless the context clearly indicates otherwise.

Hereinafter, the present disclosure will be described in detail with reference to the accompanying drawings.

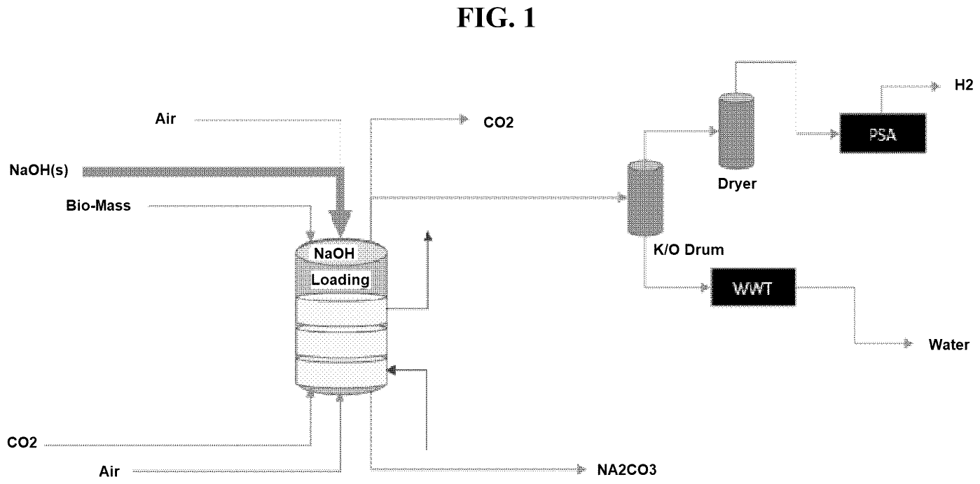

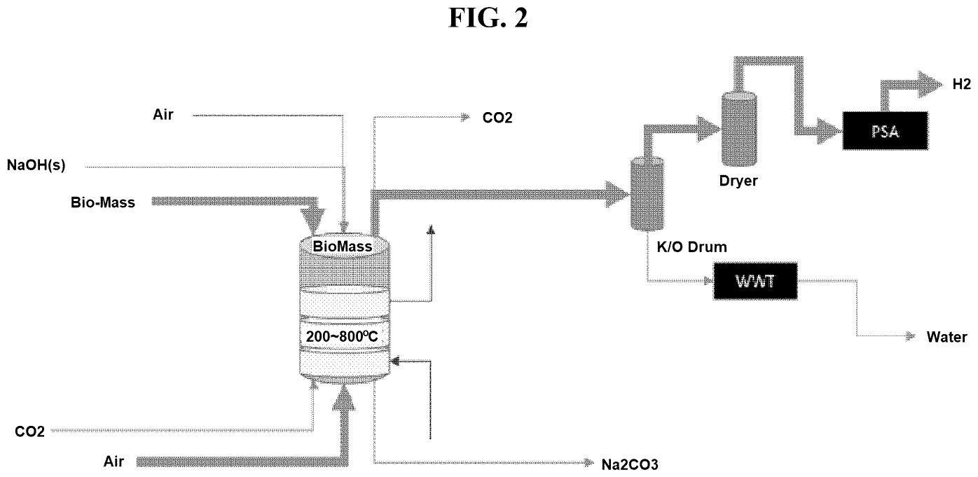

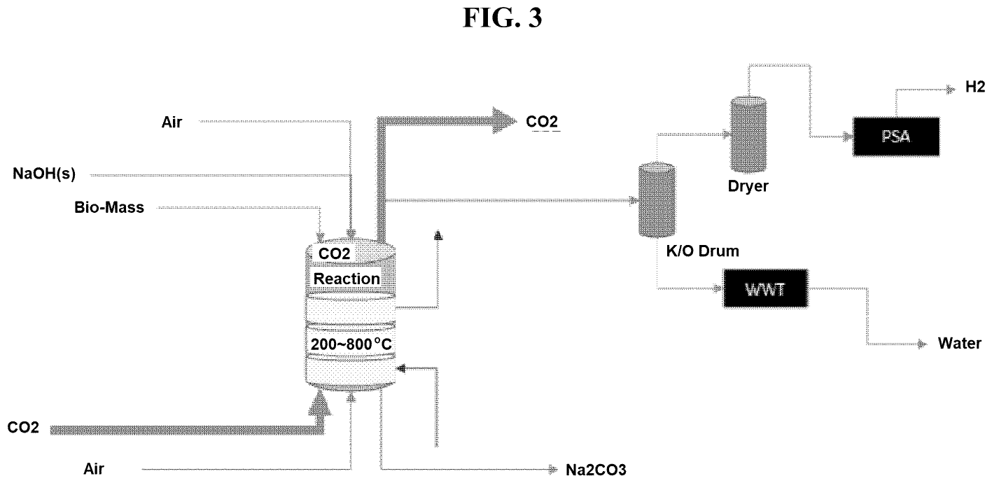

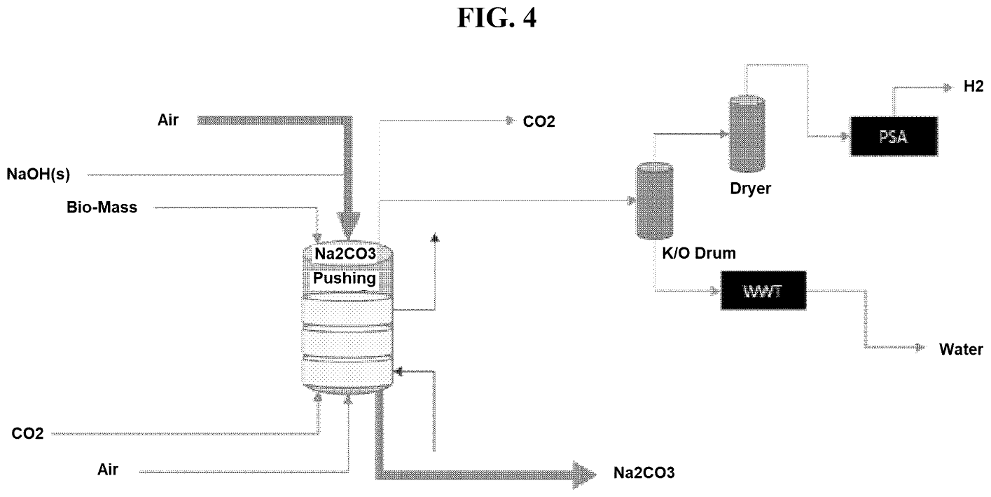

As a specific example of the present disclosure, as shown in FIGS. 1 to 4, a dry hydrogen production device from biomass according to the present disclosure preferably includes,
a reactor that reacts supplied biomass and hydroxide of at least one of alkali and alkaline earth without supplying water or vapor;
a heating means that heats the reactor to a reaction temperature of 200 to 800° C.;
a hydroxide supply line connected to the reactor to supply the hydroxide of at least one of alkali and alkaline earth thereto;
a biomass supply line connected to the reactor to supply biomass as a reactant thereto;
a carrier gas supply line connected to the reactor to discharge the reactant;
a gas phase reaction product outflow line connected to the reactor to discharge a reaction product by the carrier gas;
a solid-gas separator (K/O Drum) connected to the gas phase reaction product outflow line to separate the gas phase reaction product discharged by the gas phase reaction product outflow line; and
a gas separator connected to the solid-gas separator to further separate a gas effluent separated from the solid-gas separator.

The gas separator is preferably a pressure swing adsorption (PSA) device, but is not limited thereto as will be obvious to those skilled in the art.

Preferably, in order to treat the solid effluent separated by the solid-gas separator, a wastewater treatment device (WWT) communicating with the solid-gas separator is further included.

Preferably, in order to improve the load and performance of the gas separator, a dryer is further included between the solid-gas separator and the gas separator.

When the reaction of the biomass with hydroxide of at least one of alkali and alkaline earth is completed, it is preferable to further include a carbon dioxide supply line connected to the reactor to supply carbon dioxide for converting unreacted hydroxide into carbonate of at least one of alkali and alkaline earth.

In order to separate unreacted carbon dioxide from carbon dioxide supplied through the carbon dioxide supply line, it is preferable to further include a carbon dioxide outflow line that separates carbon dioxide from the gas effluent outflow line and then discharges the carbon dioxide.

After the alkali carbonate is generated by the carbon dioxide supplied above, it is preferable to further include a carrier gas supply line connected to the reactor to discharge the alkali carbonate from the reactor.

In order to discharge a solid product containing alkali carbonate from the reactor by the carrier gas, it is preferable to further include a solid-product discharge line connected to the reactor. It is preferable to further include a device for increasing the purity of alkali carbonate or alkaline earth metal carbonate, which is the main component of the produced solid product, without being particularly limited thereto as will be obvious to those skilled in the art.

The heating means is preferably a tube type heat exchanger using thermal oil or the like, but a general heater may also be used, without being limited thereto as will be obvious to those skilled in the art.

As another specific example of the present disclosure, a dry hydrogen production method from biomass according to the present disclosure preferably includes,
a step (1) of loading hydroxide of at least one of alkali and alkali earth into the reactor;
a step (2) of supplying biomass to the reactor;
a step (3) of producing a reaction product by heating the reactor to 200-800° C. without supplying water or vapor, while supplying carrier gas to fluidize a hydroxide and biomass mixture in the reactor;
a step (4) of discharging a gas phase reaction product from the reactor when the reaction is completed;
a step (5) of separating the gas phase reaction product into a gas effluent and a solid effluent through solid-gas separation; and
a step (6) of producing a gas product through gas-gas separation from the gas effluent.

The biomass may include organic sludge containing glucose, such as seaweed and food waste, but is not limited thereto as will be obvious to those skilled in the art. The biomass is made by drying biomass washed to remove dirt and odors to a state that contains almost no moisture. The drying method will vary as will be apparent to those skilled in the art, and is not limited to a specific method.

The hydroxide may be a compound having a metal element and a negatively charged hydroxide ion (OH−). To be more specific, the hydroxide may include an alkali metal compound in which alkali metal is bonded to a hydroxide ion (OH−), or alkaline earth metal compound in which alkaline earth metal is bonded to a hydroxide ion (OH−). For example, the hydroxide may include at least one of potassium hydroxide (KOH), sodium hydroxide (NaOH), lithium hydroxide (LiOH), calcium hydroxide (Ca(OH)2), and magnesium hydroxide (Mg(OH)2). Further, according to an embodiment, one or more hydroxides may be used in combination. According to an embodiment, the hydroxide may be introduced into a reactor in the form of a dry powder or in the form of a solution with another solvent (e.g. water). The above description of the hydroxide is merely illustrative, and the present disclosure is not limited thereto.

In a specific example according to the present disclosure, the alkali hydroxide is preferably sodium hydroxide.

Preferably, the supply amount of biomass to the loaded alkali hydroxide uses the same amount or a larger amount of hydroxide to ensure a sufficient reaction, and is preferably 1 to 3:1 (alkali hydroxide:biomass) in a dry weight ratio.

According to an embodiment of the present disclosure, a catalyst may be included. The catalyst may include a material that facilitates a gasification reaction into hydrogen by assisting the reaction of biomass and hydroxide. To be more specific, the catalyst may include at least one element selected from nickel (Ni) and iron (Fe). The catalyst may be mixed in advance with biomass and hydroxide and then introduced into the reactor. Further, the catalyst may be placed in an inorganic nanofiber structure such as zirconia, silica, alumina, or carbon.

Since the biomass, hydroxide, reaction product, etc. do not contain water, carrier gas is required throughout an overall process from a reactant to a product. The carrier gas is not limited to a specific gas within the scope of the purpose of the present disclosure, but is preferably air, nitrogen, or inert gas. Preferably, the flow rate of the carrier gas satisfies a minimum fluidization speed to induce fluidization inside the reactor.

According to the present disclosure, the step (3) of producing a reaction product is performed by heating the reactor to 200-800° C. without the presence of moisture (water) in the biomass or hydroxide and without supplying water or vapor within the reactor. Outside the above temperature range, it is undesirable because the reaction does not occur or a larger amount of by-products is produced. Especially when the temperature exceeds the above temperature range, energy consumption is significant, making it undesirable.

By heating the mixture of biomass and hydroxide above a preset temperature while introducing the carrier gas in the reactor, the gasification reaction may occur. To be more specific, when the mixture of biomass and hydroxide is placed in the reactor, the reactor may lead to the gasification reaction of the biomass by increasing a temperature inside the reactor above a preset temperature. Further, according to an embodiment, the reactor may maintain the above temperature conditions until no gasification reaction occurs in the biomass mixture. Here, the temperature of the reactor may be 200 to 800° C. based on standard pressure. Thus, the reactor may maintain temperature conditions at which carbonate and hydrogen are produced until the reaction is completed. The reactor according to another embodiment may be supplied with an additional biomass mixture before the gasification reaction of the biomass mixture is completed. In this case, the added biomass mixture may be supplied in an amount that may maintain reaction conditions in the reactor.

Here, the gasification reaction may be a chemical reaction that uses the biomass mixture containing biomass and hydroxide as a reactant and has hydrogen and carbonate as a product. To be more specific, the reactor may generate hydrogen in a gaseous state and carbonate in an ash state by heating the biomass mixture to cause the gasification reaction. Through the gasification reaction of the biomass mixture, hydrogen as a main product and carbonate as a by-product may be produced. Of course, it is obvious that impurities such as unreacted hydroxide may exist in the ash state.

In the reaction product, gas containing hydrogen flows out from the upper portion of the reactor to become a gas phase reaction product, and an ash-state solid containing carbonate flows outs from the lower portion of the reactor to become a solid product containing carbonate.

When the reaction is completed, the step (4) is performed by supplying the carrier gas, preferably air, to the reactor to discharge the gas phase reaction product.

The gas phase reaction product is further subjected to the step (5) of separating the product into a gas effluent and a solid effluent through solid-gas separation. Since the gas phase reaction product may contain a trace amount of solid product, unreacted hydroxide, and impurities, the solid effluent may be removed from the gas phase reaction product using a K/O Drum, a filter or the like. As such a means, a means obvious to those skilled in the art within the scope of the purpose of the present disclosure may be used.

Further, the step (6) is performed to produce hydrogen, which is a final gas product, by additional gas-gas separation from the gas effluent. The gas-gas separation is not particularly limited. In the present disclosure, it is preferably performed using pressure swing adsorption (PSA).

It is preferable to further include the step of drying the gas effluent before step (6). A means for removing moisture from the gas effluent is not particularly limited, and a dryer may be preferably used.

It is preferable that the solid-gas separated solid effluent is subsequently treated through a wastewater treatment step. The wastewater treatment means may employ a conventional means that is obvious to those skilled in the art.

The carbonate (M₂CO₃) may be produced through the gasification reaction of biomass and hydroxide. Here, the carbonate may include ionic crystals containing carbonate ions (CO₃²⁻). The carbonate preferably includes alkali or alkaline earth carbonate. For example, when sodium hydroxide is used as the hydroxide, hydrogen and sodium carbonate may be produced through the gasification reaction of sludge and sodium hydroxide.

It is preferable to further include a step (7) of supplying carbon dioxide to the lower portion of the reactor to convert hydroxide of at least one of unreacted alkali and alkaline earth into carbonate. In this case, the amount of carbon dioxide supplied is preferably determined considering unreacted hydroxide.

In order to separate the carbon dioxide supplied as described above, it is preferable to add a step of separately separating and discharging carbon dioxide to the step (4) of discharging the gas phase reaction product.

The solid product containing the carbonate is preferably treated through a step (8) of supplying the carrier gas, preferably air, to the upper portion of the reactor and discharging it from the lower portion of the reactor. In this case, it is preferable that an outlet is provided on the lower portion of the reactor to use gravity.

After the solid product containing the carbonate is discharged, it is preferable to add a process of removing heavy metal to increase the carbonate purity of the solid product to the lower portion. In this case, it is believed that the main component of heavy metal is chromium (Cr), which is contained in a trace amount in food waste. A method of removing the heavy metal may use an anion treatment method, a filter removal method, etc., but is not limited thereto.

Conventionally, when sodium hydroxide is not supplied to the reactor and only water vapor is supplied, hydrogen production is low, the production start temperature for the product exceeds 700° C., and the production of by-products such as carbon dioxide is large, making it undesirable.

Further, hydrogen production is possible within a desirable temperature range when using both NaOH and water vapor, but energy consumption is excessively high, making it undesirable. In contrast, according to an embodiment of the present disclosure, hydrogen production is possible at low temperature and is possible when the carrier gas is air and nitrogen. Since water or water vapor is not used, a load on the device is low and energy consumed is low, making it desirable.

Although the present disclosure has been described above with reference to preferred embodiments, it will understood by those skilled in the art that various modifications and changes may be made to the present disclosure without departing from the idea and scope of the present disclosure as set forth in the following claims.

The present disclosure is directed to a device and method for producing hydrogen from dried biomass without the supply of vapor or water.

1. A dry hydrogen production device, the device comprising:
a reactor to which water or vapor is not supplied;
heating means configured to heat the reactor to 200 to 800° C.;
a supply line for hydroxide of at least one of alkali and alkali earth connected to the reactor;
a biomass supply line connected to the reactor;
at least one carrier gas supply line connected to the reactor;
a gas phase reaction product outflow line connected to the reactor;
a solid-gas separator connected to the gas phase reaction product outflow line; and
a gas separator connected to the solid-gas separator.

2. The device of claim 1, wherein the alkali hydroxide is sodium hydroxide.

3. The device of claim 1, further comprising: a wastewater treatment device communicating with the solid-gas separator.

4. The device of claim 1, further comprising: a dryer provided between the solid-gas separator and the gas separator.

5. The device of claim 1, further comprising: a carbon dioxide supply line connected to the reactor.

6. The device of claim 1, further comprising: a carbon dioxide outflow line separating carbon dioxide from the gas phase reaction product outflow line, and discharging the carbon dioxide.

7. The device of claim 1, wherein the carrier gas is air, nitrogen, or inert gas.

8. The device of claim 1, further comprising: a solid-product discharge line connected to the reactor.

9. The device of claim 8, wherein the solid product comprises carbonate of at least one of alkali and alkaline earth.

10. The device of claim 8, wherein the solid product comprises sodium carbonate.

11. The device of claim 8, further comprising: a device connected to a rear end of the solid-product discharge line to increase purity of the solid product.

12. The device of claim 1, wherein the gas separator is a pressure swing adsorption (PSA) device.

13. The device of claim 1, wherein the heating means is a tube type heat exchanger.

14. A dry hydrogen production method, the method comprising steps of:
loading hydroxide of at least one of alkali and alkali earth into the reactor;
supplying biomass to the reactor;
producing a reaction product by heating the reactor to 200-800° C. without supplying water or vapor, while supplying carrier gas to fluidize a hydroxide and biomass mixture in the reactor;
discharging a produced gas phase reaction product from the reactor;
separating the gas phase reaction product into a gas effluent and a solid effluent through solid-gas separation; and
producing a gas product through gas-gas separation from the gas effluent.

15. The method of claim 14, wherein the alkali hydroxide is sodium hydroxide.

16. The method of claim 14, further comprising: a wastewater treatment step for treating the solid effluent separated from the solid-gas separation.

17. The method of claim 14, further comprising a step of: drying the gas effluent prior to the step.

18. The method of claim 14, further comprising a step of: supplying carbon dioxide to a lower portion of the reactor to convert hydroxide of at least one of alkali and alkaline earth into carbonate of at least one of alkali and alkaline earth.

18. The method of claim 14, further comprising a step of: separately separating and discharging carbon dioxide during the step of discharging the gas phase reaction product.

20. The method of claim 18, further comprising a step of: supplying the carrier gas to an upper portion of the reactor to discharge a solid product containing carbonate of at least one of alkali and alkaline earth from the lower portion of the reactor.

21. The method of claim 14, wherein the carrier gas is air, nitrogen, or inert gas.

22. The method of claim 18, wherein the alkali carbonate is sodium carbonate.

23. The method of claim 20, further comprising a step of: increasing purity of the solid product subsequent to the step of discharging the solid product from the lower portion of the reactor.

24. The method of claim 14, wherein a supply amount of biomass to the loaded alkali hydroxide is 1 to 3:1 (alkali hydroxide:biomass) in a dry weight ratio.
